(19) United States
(12) Patent Application Publication
(10) Pub. No.: US 2017/0241140 A1
(43) Pub. Date: Aug. 24, 2017

(54) REINFORCING MEMBERS FOR CONCRETE STRUCTURES

(71) Applicant: The Hong Kong Polytechnic University, Hung Hom (HK)

(72) Inventors: Jin-Guang TENG, Hung Hom (HK); Bing ZHANG, Nanjing (CN)

(21) Appl. No.: 15/435,865

(22) Filed: Feb. 17, 2017

Related U.S. Application Data
(60) Provisional application No. 62/297,130, filed on Feb. 18, 2016.

(51) Int. Cl. E04C 5/07; B29C 70/32; B29C 70/52; E04C 3/34; E04C 3/36

(52) U.S. Cl. CPC E04C 5/073; E04C 3/34; E04C 3/36; B29C 70/52; B29C 70/32; B29K 2307/04

(57) ABSTRACT

In a broad aspect of the present disclosure there is provided a reinforcing member for reinforcing a concrete structure, methods of manufacturing the member and a composite concrete column comprising the member for reinforcing concrete structures. The member has a longitudinally extending elongate rod comprising a fiber reinforced polymer. A tubular sheath is spaced apart from and extending around the elongate rod so as to define a volume thereabout. The volume is filled with substantially incompressible material.

### FIELD

The present disclosure relates to improved reinforcing bars for concrete structures and, more particularly, to fiber reinforced polymer (FRP) reinforcing members.

### BACKGROUND

Reinforcing bars (rebar) (typically steel) are embedded within concrete in a vast array of different structures including roads, bridges, tunnels and buildings. Rebars reinforce concrete, which is naturally strong under compressive loading but is much weaker under tensile loading. Rebars provide primary reinforcement to resist loads; as well as secondary reinforcement to resist stresses arising from temperature change and shrinkage.

A known problem associated with embedding rebars within concrete is that where corrosion and degradation of the rebars occurs, the formation of corrosion products (including oxides) takes up significantly more volume than the steel from which it originates. Increased volume leads to increased internal pressures on the surrounding concrete, which can lead to cracking and spelling, which in turn increases corrosion and potentially leads to catastrophic structural failure. Corrosion of the (often untreated) rebar is also associated with reduced tensile resistance. Where corrosion of the rebar has taken place, this has a significant environmental and financial cost, as it generally must be replaced as this is extremely difficult to repair.

Fiber Reinforced Polymers (FRP) rebars are typically formed by pultrusion and consist of continuous fibers (e.g. glass, carbon, aramid or basalt fibers) embedded in a resin matrix (e.g. polyester, vinyl ester or epoxy), FRP rebars have been used as one solution to the problems associated with steel corrosion, for specific application such as highly corrosive internal/external environments (such as marine structures) or where electro-magnetic transparency is required (e.g. hospital buildings housing magnetic resonance equipment). Additionally, applications such as seawater sea-sand concrete are inherently more suitable for FRP rebars rather than traditional steel.

However, FRP rebars are generally mainly used in flexural members such as beams or slabs. The use of FRP rebars in concrete columns has been relatively uncommon due to a number of significant concerns.

Concerns about FRP rebars include microbuckling or ‘kinking” of the fiber within the restraints of the matrix of the material where FRP rebars are placed under axial compression, such as in concrete columns. This microbuckling means FRP rebars have a significantly lower strength under compressive loads as compared to tensile loads; and cyclic loading (such as under seismic activity) can cause significant damage. Unless the FRP rebar is well supported by stirrups or surrounding concrete, the rebars buckle easily due to its high strength to modulus ratio. The FRP rebar typically has a brittle failure mode in both tension and compression.

Finally, even where the above do not occur, in a concrete column under compressive crushing force, the minimal strain capacity of concrete relative to the higher strain capacity of FRP means that any compressive strength provided by FRP rebars to the concrete column is limited.

Accordingly, it is an object of the present disclosure to provide a reinforcing member which addresses at least some of the above problems or provides an alternative.

### SUMMARY OF THE INVENTION

In a first aspect, the present disclosure provides a reinforcing member for reinforcing a concrete structure comprising:

a longitudinally extending elongate rod comprising a fiber reinforced polymer,

a tubular sheath spaced apart from and extending around the elongate rod so as to define a volume thereabout, wherein the volume is filled with substantially incompressible material.

Advantageously, the elongate rod is centred in the tubular sheath.

Optionally, the elongate rod may comprise a first fiber reinforced polymer and the tubular sheath may comprise a second fiber reinforced polymer which is different from the first fiber reinforced polymer.

At least one of the elongate rod and the tubular sheath may have a circular cross section.

Advantageously, the substantially incompressible material in the volume does not contain coarse aggregate and is selected from the group comprising ultra-high performance concrete, cement mortar, cement and resin modified cement.

The substantially incompressible material in the volume may have a compressive strength of between 100 and 300 MPa.

The outer surface of the tubular sheath may have a coating or structural features for increasing bonding with the concrete of the concrete structure, wherein the coating may comprise sand mixed with resin.

The elongate rod may be made from fibers selected from the group including glass fibers, carbon fibers, basalt fibers, aramid fibers dispersed in a resin matrix selected from the group comprising epoxy resin, vinyl ester resin and polyester resin.

The tubular sheath may comprise fibers selected from the group including glass fibers, carbon fibers, basalt fibers, aramid fibers dispersed in a resin matrix.

In a further aspect of the disclosure there is provided a method of manufacturing reinforcing members for reinforcing concrete comprising:

combining a longitudinally extending elongate rod formed from a fiber reinforced polymer in a mould with a substantially incompressible material extending about the elongate rod to form a generally elongate member,

winding a plurality of filaments around the generally elongate member to form a tubular sheath.

The longitudinally extending elongate rod may be manufactured by a continuous manufacturing process for forming rods having a substantially constant cross section.

The filaments in the tubular sheath may be oriented in the hoop direction to provide confinement of the substantially incompressible material under load.

Features for increasing bonding of the reinforcing member to the surrounding concrete may be provided on the outer surface of the tubular sheath, including structural features formed on the outer surface of the tubular sheath or including applying a resin including sand dispersed thereon to the outer surface of the tubular sheath.

In a further aspect of the disclosure there is provided a method of manufacturing reinforcing members for reinforcing concrete comprising:

inserting a longitudinally extending elongate rod formed from a fiber reinforced polymer into a tubular sheath spaced apart from and extending circumferentially around the elongate rod so as to define a volume thereabout,

filling the volume with substantially incompressible material.

Advantageously, the longitudinally extending elongate rod is manufactured by a continuous manufacturing process to form a rod having a substantially constant cross section.

Filaments in the tubular sheath may be oriented in the hoop direction to provided confinement of the substantially incompressible material under load.

Features for increasing bonding of the reinforcing member to the surrounding concrete may be provided on the outer surface of the tubular sheath, where such features may include structural features formed on the outer surface of the tubular sheath or may be provided by applying a resin including sand dispersed therein to the outer surface of the tubular sheath.

In yet a further aspect of the disclosure there is provided a composite concrete column comprising at least one reinforcing member, the reinforcing member comprising a longitudinally extending elongate rod formed from a fiber reinforced polymer, and a tubular sheath

spaced apart from and extending circumferentially around the elongate rod so as to define a chamber thereabout, wherein the chamber is filled with substantially incompressible material,

a concrete column extending about the reinforcing member.

### BRIEF DESCRIPTION OF THE FIGURES

Preferred embodiments of the present disclosure will be explained in further detail below by way of example and with reference to the accompanying drawings, in which:

FIG. 1a shows a schematic cross section view of an exemplary concrete reinforcing member according to an aspect of the present disclosure;

FIG. 1b shows a schematic cross sectional view of a further exemplary concrete reinforcing member according to an aspect of the present disclosure;

FIG. 1c shows a schematic cross sectional view of a further exemplary concrete reinforcing member according to an aspect of the present disclosure;

FIG. 1d shows a schematic cross sectional view of a further exemplary concrete reinforcing member according to an aspect of the present disclosure;

FIG. 1e shows a schematic cross sectional view of a further exemplary concrete reinforcing member according to an aspect of the present disclosure;

FIG. 2a shows a view of testing equipment setup used for testing the compressive loading behaviour of various concrete reinforcing members;

FIG. 2b shows a planar view of the hoop strain gauges attached at mid-height of the external surface of the FRP jacket of the device of FIG. 2a.

FIG. 2c shows an exemplary graph depicting detected axial strains and hoop strains when using the device of FIGS. 2a, 2b.

FIG. 3a depicts an exemplary view of a concrete reinforcing member prior to testing;

FIG. 3b depicts an exemplary view of the concrete reinforcing member after failure during testing;

FIG. 4 shows a stress/strain graph of the various concrete reinforcing members under axial compression; and

FIG. 5 shows predicted stress/strain graphs with various concrete reinforcing members under axial compression.

### DETAILED DESCRIPTION OF THE PREFERRED EMBODIMENTS

The present disclosure provides in broad aspects a concrete reinforcing member, a column including reinforcing members and methods of making the reinforcing member.

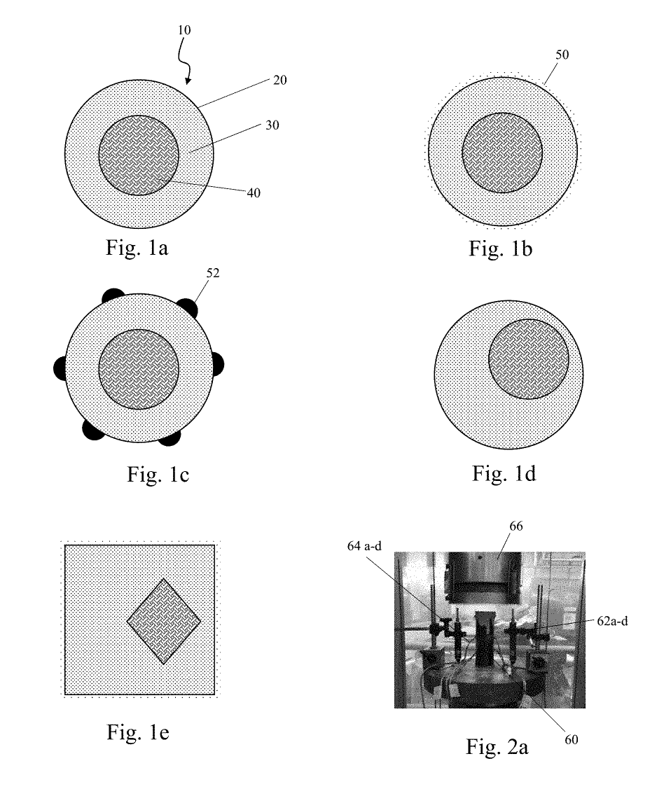

Referring to FIGS. 1a-1e, the concrete reinforcing member 10 comprises an external sheath 20 which encases substantially incompressible material 30 (such as concrete) and a rod 40.

As depicted in FIG. 1b, an additional external layer 50 for increasing bonding of the concrete reinforcing member with surrounding material may be provided. Alternatively, surface projections 52 (such as spiral ribs formed by spiral winding of fibers with resin) for increasing bonding of the concrete reinforcing member may be provided external of the sheath as shown in FIG. 1c. This may be further enhanced by the inclusion of sand coating included in the resin in the production process.

Persons skilled in the art would appreciate that the rod 40 may be located so as to extend along the central longitudinal axis of the concrete reinforcing member 10 as depicted in FIGS. 1a-1c. However, it would be appreciated that it would not be limited to this location. As shown in the FIGS. 1d and 1e, the rod 40 may be located off centre, without departing from the present invention.

It would be appreciated that the rod 40 and the tubular sheath/sleeve 20 may be made from the same materials or from different materials.

Advantageously, the rod may be made from fiber reinforced polymer—for example glass, basalt, carbon, aramid or similar fibers in a thermoset resin matrix or another suitable matrix material. Generally, the fibers of the rod are aligned parallel or substantially parallel to the longitudinal axis of the rod to provide resistance to the application of axial stresses, particularly in tension.

Advantageously, and as is known in the art, the rod (having a generally constant cross section) may be formed by a continuous manufacturing process such as pultrusion, whereby the reinforcing fibers are saturated with liquid resin and then pulled through a heated die. Using this process, the rods can be formed with a constant cross section and to the shippable length required.

Advantageously, and as is known in the art, the tubular sheath/sleeve may be manufactured using a filament winding technique, wherein the resin-bathed filaments under tension are wound over a cylindrical mould with the fiber volume ratio, fiber angle and the stacking sequence controlled.

The tubular sleeve/sheath 20 forms a “jacket” about the reinforcing member and may be made by filament winding of the fibers with various orientations so as to provide resistance and stiffness in both the hoop and axial directions. It would be appreciated by persons skilled in the art that the hoop strength and resistance ensures sufficient confinement of the substantially incompressible material 30; and the axial stiffness and resistance bridge cracks in the filler material under axial tension.

As depicted it is envisaged that the sleeve/sheath is relatively “thin” when compared to the rod and the amount of filling material, confining the filler material as described.

The substantially incompressible material confined between the rod 40 and the sheath/sleeve 20 may be formed from ultra-high performance concrete, UHPC. As is known in the art, UHPC currently has a compressive strength of up to or possibly exceeding 250 MPa (although it is envisaged that a wide range of strengths typically above 150 MPa could also be utilised).

Other flowable substantially incompressible materials such as cement mortar, or other cement based high strength materials could also be utilised as the substantially incompressible material without departing from the scope of the present invention. Advantageously, the incompressible material is free of coarse aggregate in view of space constraints of the filler material.

Referring to FIGS. 1a-1e, it would be appreciated that although the cross sectional shape depicted of the reinforcing member as a whole in FIGS. 1a-1c is circular, as shown in the embodiments depicted in FIG. 1 e, it should be appreciated that the disclosure is not limited to reinforcing members having this shape. Other shaped cross sections are possible, including square, rectangular, polygonal or elliptical cross sections; and depending upon the requirements of the application for which the reinforcing member as a whole will be utilised.

Similarly, the cross sectional shape of the rod is depicted as circular in the embodiments shown in FIG. 1a-e, although it would be appreciated that other geometries would be possible without departing from the present invention, depending upon the required shape of the reinforcing member and the application for which it is used.

Multiple reinforcing members of the present disclosure could be used in reinforcing a concrete column, similar to the present approach with steel bar reinforced concrete column. Additionally, multiple rods could be used within the same overall reinforcing member without departing from the scope of the present disclosure.

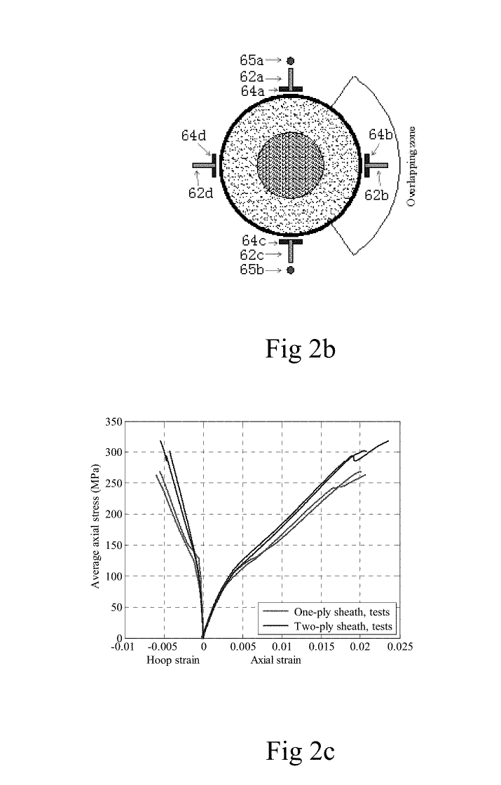

FIGS. 2a, 2b depict an exemplary testing rig in which the behaviour of the reinforcing members of the present disclosure may be examined under compressive load. In particular, FIG. 2b shows a planar view of the hoop strain gauges attached at mid-height of the external surface of the FRP jacket of the device of FIG. 2a.

The reinforcing members 60, were tested under uniaxial compression using a 4,600 kN testing machine 66, at the Concrete Technology Laboratory of the Hong Kong Polytechnic University. The loading of the specimens was conducted at a constant controlled displacement rate of 0.1 mm/min. Axial load and displacement were monitored with a frequency of 5 Hz.

As depicted strain gauges 62a, 62b, 62c, 62d were attached to measure the longitudinal strain vertically at the midheight of each section.

Hoop strains 64a, 64b,64c, 64d were also measured in this testing rig using strain gauges, with the results as depicted in the attached figure FIG. 2c, wherein axial compressive strain is represented as positive, and hoop tensile strain is depicted as negative.

Linear Variable Differential Transformer (LVDT) 65a, 65b were also included to monitor axial shortening/axial strains.

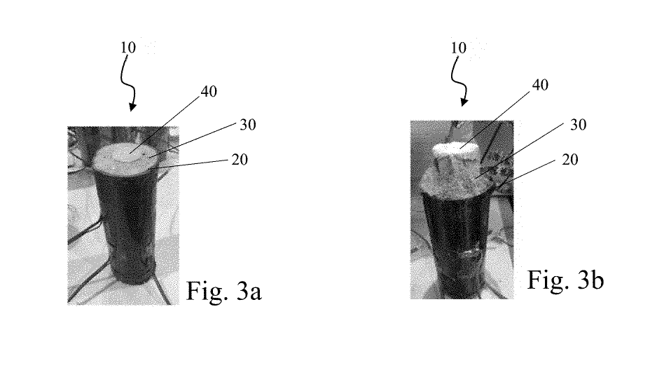

Referring to FIG. 3a, there is depicted an exemplary reinforcing member used in the test rig, which was produced by wrapping a carbon FRP (CFRP) jacket or sheath around a cured high strength cement mortar bar reinforced with a central FRP rod. The fibers in the central FRP rod were oriented longitudinally to resist axial stresses, while the fibers in the jacket or sheath were oriented in the hoop direction to provide confinement.

Referring to FIG. 3b, there is shown the exemplary reinforcing member 10 of FIG. 3a after the test has been conducted. Again, the central rod 40 and substantially incompressible filler material 30 is visible, as well as the surrounding jacket or sheath 20.

Four reinforcing members having a diameter of 50 mm were tested. Jiang and Teng's (2007) model for FRP-confined concrete [applicable to high-strength concrete as well, see Xiao et al. (2010)] was directly used to predict the behaviour of FRP-confined cement mortar while the behaviour of the FRP rebar was taken to be the same as that under tension determined in the pilot study.

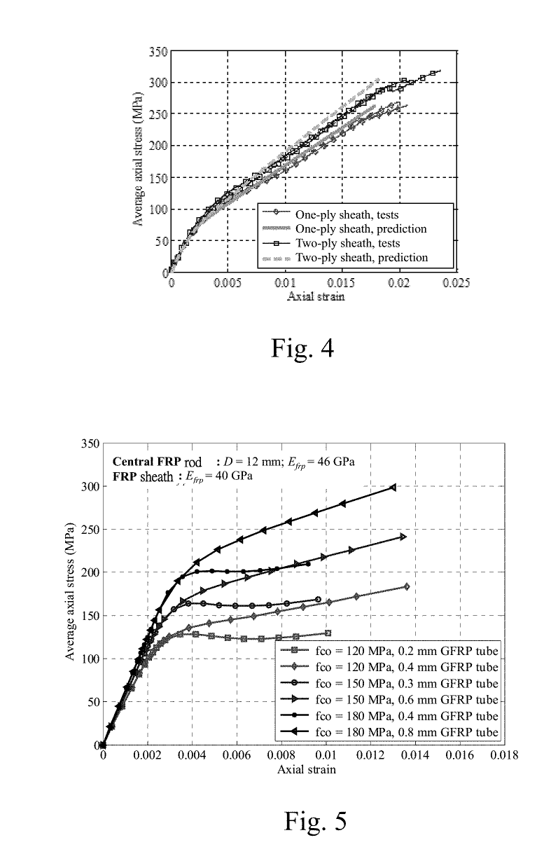

Referring to FIG. 4, it can be seen that the predicted curves end at a point when the hoop rupture strain of the CFRP jacket is reached. (It should be noted that this rupture strain for the concrete reinforcing members with a one-ply FRP sheath was obtained from tests on the corresponding FRP-confined cement mortar specimens due to some problems with the measurement of hoop rupture strain).

FIG. 4 shows that the predictions agree closely with the test results and the axial stress-strain curves show a strong hardening response after “yielding” due to the high level of confinement.

FIG. 5 shows stress-strain curves of rebars of various combinations of the three constituent materials (i.e., the FRP rod, the FRP sheath, and the substantially incompressible layer in between) predicted using Jiang and Teng's model which, according to the study by Zohrevand and Mirmiran (2011), should provide reasonable approximations of the behaviour of FRP confined Ultra High Performance Concrete.

FIG. 5 also demonstrates that the stress-strain response of the concrete reinforcing members can be designed to suit the needs of a specific application (e.g. to exhibit an “elastic-plastic” response with strain hardening).

Jiang, T and Teng, J. G. (2007). “Analysis-oriented stress-strain models for FRP-confined concrete”, Engineering Structures, 29(11), 2968-86.

Xiao, Q. G., Teng, J. G. and Yu, T. (2010). “Behavior and modeling of confined high-strength concrete”, Journal of Composites for Construction, ASCE, 14(3), 249-259.

Zohrevand, P and Mirmiran, A. (2011). “Behavior of ultrahigh-performance concrete confined by fiber-reinforced polymers”, Journal of Materials in Civil Engineering, ASCE, 23(12), 1727-1734.

Based on the above tests, the outstanding characteristics of the improved concrete reinforcing members of the disclosure can be summarized as follows:

First, as the rod at the center is so well confined/supported by the substantially incompressible material that rod buckling and fiber micro-buckling are both prevented. This in turns means that the improved concrete reinforcing members of the disclosure can be designed to show similar/desired mechanical resistances in both tension (provided mainly by the rod) and compression (provided by both the rod and the substantially incompressible material). This is a significant improvement over the existing FRP reinforcing members presently available.

Second, due to the prevention of the rod buckling and fiber micro-buckling, cyclic loading (as is commonly experienced in areas with seismic activity) is expected to have little effect on the mechanical properties of the rod.

Third, the compressive strength of the rod can be fully utilized, with the strength reserve beyond the crushing strain of the substantially incompressible material being mobilized to balance the post-peak softening response of the substantially incompressible material to produce a “yield” plateau or a post-“yielding” strain-hardening response for the concrete reinforcing member.

Fourth, the stress-strain response of the improved concrete reinforcing members of the disclosure can be designed to meet pre-set requirements (e.g. to exhibit an “elastic-plastic” response like that of steel as shown in FIG. 5).

Fifth, the improved concrete reinforcing members of the disclosure have a much better transverse shear resistance than standard FRP rebars due to the presence of the external sheath/sleeve tube with appropriate fiber orientations.

Finally, the above characteristics ensure that the improved concrete reinforcing members of the disclosure will perform well as longitudinal reinforcement under tension-compression cycles in concrete members subjected to seismic loading.

While the present disclosure has been explained by reference to the examples or preferred embodiments described above, it will be appreciated that those are examples to assist understanding of the present disclosure and are not meant to be restrictive. Variations or modifications which are obvious or trivial to persons skilled in the art, as well as improvements made thereon, should be considered as equivalents of this disclosure.

1. A reinforcing member for reinforcing a concrete structure comprising:
a longitudinally extending elongate rod comprising a fiber reinforced polymer, and
a tubular sheath spaced apart from and extending around the elongate rod so as to define a volume thereabout, wherein the volume is filled with substantially incompressible material.

2. The reinforcing member according to claim 1 wherein the elongate rod is centred in the tubular sheath.

3. The reinforcing member according to claim 1 wherein the elongate rod comprises a first fiber reinforced polymer and wherein the tubular sheath comprises a second fiber reinforced polymer which is different from the first fiber reinforced polymer.

4. The reinforcing member according to claim 1 wherein at least one of the elongate rod and the tubular sheath have a circular cross section.

5. The reinforcing member according to claim 1 wherein the substantially incompressible material in the volume does not contain coarse aggregate and is selected from the group comprising ultra-high performance concrete, cement mortar, cement and resin modified cement.

6. The reinforcing member according to claim 5 wherein the substantially incompressible material in the volume has a compressive strength of between 100 and 300 MPa.

7. The reinforcing member according to claim 1 wherein the outer surface of the tubular sheath has a coating or structural features for increasing bonding with the concrete of the concrete structure.

8. The reinforcing member according to claim 7 wherein the coating for increasing bonding comprises sand mixed with resin.

9. The reinforcing member of claim 1 wherein the elongate rod is made from fibers selected from the group including glass fibers, carbon fibers, basalt fibers, aramid fibers dispersed in a resin matrix selected from the group comprising epoxy resin, vinyl ester resin and polyester resin.

10. The reinforcing member of claim 1 wherein the tubular sheath comprises fibers selected from the group including glass fibers, carbon fibers, basalt fibers, aramid fibers dispersed in a resin matrix.

11. A method of manufacturing reinforcing members for reinforcing concrete comprising:
combining a longitudinally extending elongate rod formed from a fiber reinforced polymer in a mould with a substantially incompressible material extending about the elongate rod to form a generally elongate member, and
winding a plurality of filaments around the generally elongate member to form a tubular sheath.

12. The method of manufacturing reinforcing members according to claim 11 wherein the longitudinally extending elongate rod is manufactured by a continuous manufacturing process for forming rods having a substantially constant cross section.

13. The method of manufacturing reinforcing members according to claim 12 wherein the filaments in the tubular sheath are oriented in the hoop direction to provide confinement of the substantially incompressible material under load.

14. The method of manufacturing reinforcing members according to claims 11 wherein features for increasing bonding of the reinforcing member to surrounding concrete are provided on the outer surface of the tubular sheath.

15. The method of manufacturing reinforcing members according to claim 14 wherein the features for increasing bonding of the reinforcing member to surrounding concrete are structural features formed on the outer surface of the tubular sheath.

16. The method of manufacturing reinforcing members according to claim 14 wherein the features for increasing bonding of the reinforcing member to surrounding concrete are formed by applying a resin including sand dispersed thereon to the outer surface of the tubular sheath.

17. A method of manufacturing reinforcing members for reinforcing concrete comprising:
inserting a longitudinally extending elongate rod formed from a fiber reinforced polymer into a tubular sheath spaced apart from and extending circumferentially around the elongate rod so as to define a volume thereabout, and
filling the volume with substantially incompressible material.

18. The method of manufacturing reinforcing members according to claim 17 wherein the longitudinally extending elongate rod is manufactured by a continuous manufacturing process to form a rod having a substantially constant cross section.

19. The method of manufacturing reinforcing members according to claim 17 wherein the filaments in the tubular sheath are oriented in the hoop direction to provided confinement of the substantially incompressible material under load.

20. The method of manufacturing reinforcing members according to any one of claim 17 wherein features for increasing bonding of the reinforcing member to surrounding concrete are provided on the outer surface of the tubular sheath.

21. The method of manufacturing reinforcing members according to claim 20 wherein the features for increasing bonding of the reinforcing member to surrounding concrete are at least one or more structural features formed on the outer surface of the tubular sheath.

22. The method of manufacturing reinforcing members according to claim 20 wherein the features for increasing bonding of the reinforcing member to surrounding concrete are provided by applying a resin including sand dispersed therein to the outer surface of the tubular sheath.

23. A composite concrete column comprising
at least one reinforcing member, the reinforcing member comprising a longitudinally extending elongate rod formed from a fiber reinforced polymer, and a tubular sheath,
spaced apart from and extending circumferentially around the elongate rod so as to define a chamber thereabout, wherein the chamber is filled with substantially incompressible material, and
a concrete column extending about the reinforcing member.

24. The method of manufacturing reinforcing members according to claim 11 wherein the filaments in the tubular sheath are oriented in the hoop direction to provide confinement of the substantially incompressible material under load.
